(19) United States
(12) Patent Application Publication
(10) Pub. No.: US 2024/0010119 A1
(43) Pub. Date: Jan. 11, 2024

(54) Bucket Holding Assembly

(71) Applicant: Michael Harris, Temple, TX (US)

(72) Inventor: Michael Harris, Temple, TX (US)

(21) Appl. No.: 17/860,888

(22) Filed: Jul. 8, 2022

(51) Int. Cl. B60P 7/08

(52) U.S. Cl. CPC B60P 7/0892; B62D 33/0273

(57) ABSTRACT

A bucket holding assembly for securing a bucket in bed of a truck includes a truck has a bed and a tailgate hingedly attached to the bed. A holding unit is provided and the holding unit is positionable on the bed. The holding unit has a pair of grips which each grip the bed thereby inhibiting the holding unit from sliding in the bed. The holding unit has a receiver for insertably receiving a bucket for securing the bucket on the bed.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention.

The disclosure relates to holding devices and more particularly pertains to a new 30 holding device for securing a bucket in a bed of a truck. The device includes a plate, a pair of tabs extending downwardly from the plate and an annular panel attached to the plate. The plate is positionable in a bed of a truck such that each of the tabs abuts a rear edge of the bed. A bucket is positionable in the annular ring to inhibit the bucket from sliding in the bed.

### (2) Description of Related Art Including Information Disclosed Under 37 CFR 1.97 and 1.98.

The prior art relates to holding devices including bucket holder that includes a block with a well for receiving a bucket and a pair of brackets that each engage a top step of a ladder for securing a bucket to the ladder. The prior art discloses a tool tray that is mountable to a ladder which includes a support panel, a pair of brackets attached to the support panel which each includes arms to engage legs of a ladder and an annular ring for receiving a paint bucket. The prior art discloses a bucket restraint that includes a panel with a pair of lobes being spaced from each other and an annular ring extending upwardly from the panel for receiving a bucket. The prior art discloses a bucket holder that includes a base panel, a plurality of legs extending upwardly from the panel and a pair of rings each attached to respective ones of the legs for surrounding a respective pair of buckets.

### BRIEF SUMMARY OF THE INVENTION

An embodiment of the disclosure meets the needs presented above by generally comprising a truck has a bed and a tailgate hingedly attached to the bed. A holding unit is provided and the holding unit is positionable on the bed. The holding unit has a pair of grips which each grip the bed thereby inhibiting the holding unit from sliding in the bed. The holding unit has a receiver for insertably receiving a bucket for securing the bucket on the bed.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a top perspective view of a bucket holding assembly according to an embodiment of the disclosure.

FIG. 2 is a top view of an embodiment of the disclosure.

FIG. 3 is a back view of an embodiment of the disclosure.

FIG. 4 is a right side view of an embodiment of the disclosure.

FIG. 5 is a back perspective in-use view of an embodiment of the disclosure.

FIG. 6 is a top perspective in-use view of an embodiment of the disclosure.

### DETAILED DESCRIPTION OF THE INVENTION

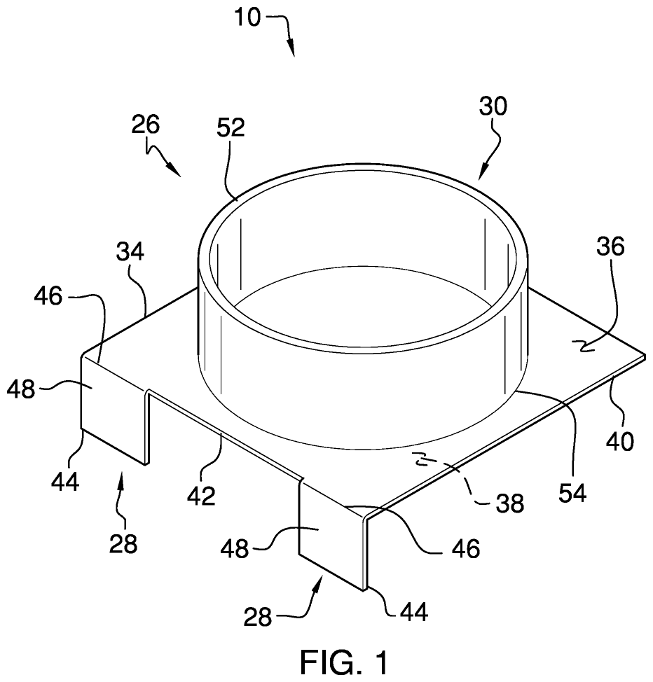

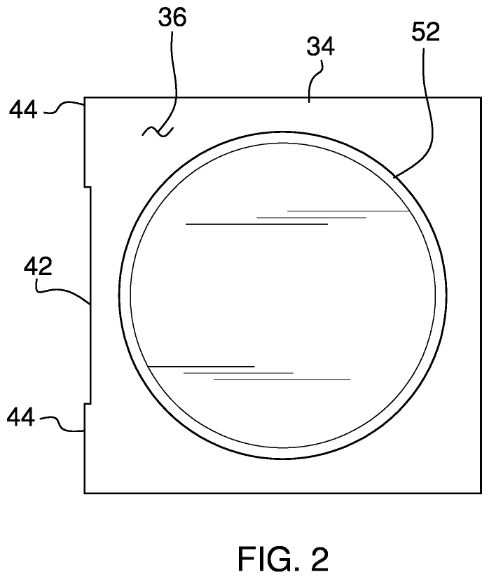

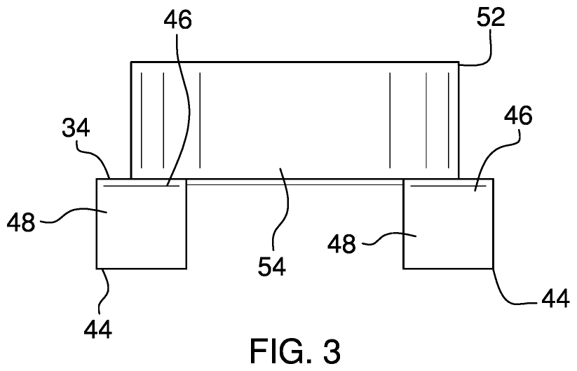

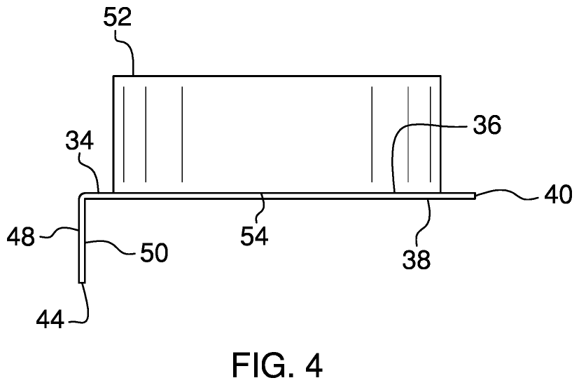

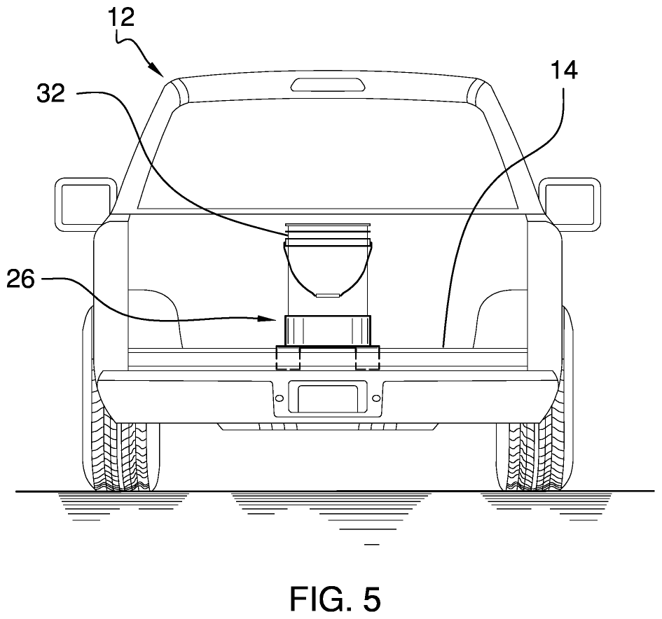

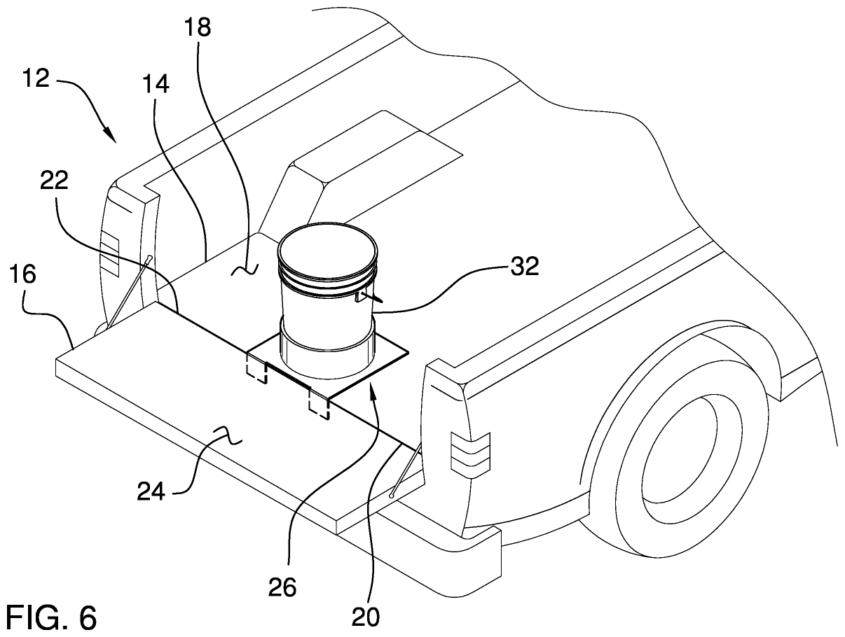

With reference now to the drawings, and in particular to FIGS. 1 through 6 thereof, a new holding device embodying the principles and concepts of an embodiment of the disclosure and generally designated by the reference numeral 10 will be described.

As best illustrated in FIGS. 1 through 6, the bucket holding assembly 10 generally comprises a truck 12 that has a bed 14 and a tailgate 16 hingedly attached to the bed 14. The bed 14 has a top surface 18 and a rear edge 20, and the tailgate 16 has a bottom edge 22 and a front surface 24. The bottom edge 22 is spaced from the rear edge 20 when the tailgate 16 is positioned in an open position and the front surface 24 lies on a plane that is perpendicularly oriented with the top surface 18 of the bed 14 when the tailgate 16 is closed. The truck 12 may be a pickup truck, a cargo truck or any other type of motorized vehicle that might be driven on public roadways and which has a bed 14 and a tailgate 16.

A holding unit 26 provided and the holding unit 26 is positionable on the bed 14. The holding unit 26 has a pair of grips 28 which each grip the bed 14 thereby inhibiting the holding unit 26 from sliding in the bed 14. Additionally, the holding unit 26 has a receiver 30 for insertably receiving a bucket 32 to secure the bucket 32 on the bed 14. 15 The bucket 32 may be a five gallon bucket or any other cylindrical object may be positioned in the receiver 30. The holding unit 26 comprises a plate 34 that has an upper surface 36, a bottom surface 38 and a perimeter edge 40 extending between the upper surface 36 and the bottom surface 38. The perimeter edge 40 has a first side 42, the bottom surface 38 rests against the top surface 18 of the bed 14 has the first side 42 is aligned with the rear edge 20 of the bed 14.

A pair of tabs 44 is provided and each of the tabs 44 has an upper edge 46, a rear face 48 and a front face 50. The upper edge 46 of each of the tabs 44 is coupled to the first side 42 of the perimeter edge 40 of the plate 34 such that each of the tabs 44 defines a respective one of the grips 28 of the holding unit 26. Additionally, each of the tabs 44 is oriented to lie on a plane that is perpendicularly oriented with the bottom surface 38 of the plate 34 such that each of the tabs 44 extends downwardly from the plate 34. The front face 50 of each of the tabs 44 abuts the rear edge 20 of the bed 14 thereby inhibiting the plate 34 from sliding forwardly in the bed 14 when the truck 12 is driving. The rear face 48 abuts the front surface 24 of the tailgate 16 when the tailgate 16 is closed thereby inhibiting the plate 34 from sliding rearwardly in the bed 14 when the truck 12 is driving.

An annular panel 52 is provided that has a lower edge 54 and the lower edge 54 is coupled to the upper surface 36 of the plate 34 such that the annular plate 34 defines the receiver 30. Furthermore, the annular panel 52 surrounds the bucket 32 when the bucket 32 is placed on the plate 34 for restraining the bucket 32. The annular panel 52 is centrally positioned on the plate 34 and the annular panel 52 defines a closed ring. Each of the plate 34, the tabs 44 and the annular panel 52 are comprised of a rigid material, including but not being limited to, plastic or metal. Furthermore, each of the annular panel 52 and tabs 44 may be welded to the plate 34 or each of the annular panel 52, the plate 34 and each of the tabs 44 may be a unitary structure.

In use, the tailgate 16 is opened and the plate 34 is positioned on the top surface 18 of the bed 14 such that each of the tabs 44 abuts the rear edge 20 of the bed 14. In this way the tabs 44 inhibit the plate 34 from sliding forwardly on the bed 14. The bucket 32 is positioned on the plate 34 such that the annular panel 52 surrounds the bucket 32 thereby restraining the bucket 32 on the plate 34. The tailgate 16 is closed thereby inhibiting the plate 34 from sliding rearwardly in the bed 14. In this way the bucket 32 is secured while the truck 12 is driving. Furthermore, the bucket 32 is positioned in an easily accessible location to facilitate the bucket 32 to be removed from the bed 14.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A bucket holding assembly for securing a bucket in a bed of a truck, said assembly comprising:
a truck having a bed and a tailgate hingedly attached to said bed; and
a holding unit being positionable on said bed, said holding unit having a pair of grips which each grip said bed thereby inhibiting said holding unit from sliding in said bed, said holding unit having a receiver for insertably receiving a bucket for securing the bucket on said bed.

2. The assembly according to claim 1, wherein said holding unit comprises:
a plate having an upper surface, a bottom surface and a perimeter edge extending between said upper surface and said bottom surface, said perimeter edge having a first side, said bottom surface resting against said top surface of said bed having said first side being aligned with said rear edge of said bed; and
a pair of tabs, each of said tabs having an upper edge, a rear face and a front face, said upper edge of each of said tabs being coupled to said first side of said perimeter edge of said plate such that each of said tabs defines a respective one of said grips of said holding unit.

3. The assembly according to claim 2, wherein:
said bed has a top surface and a rear edge, said tailgate having a bottom edge and a front surface, said bottom edge being spaced from said rear edge when said tailgate is positioned in an open position, said front surface lying on a plane being perpendicularly oriented with said top surface of said bed when said tailgate is closed; and
each of said tabs is oriented to lie on a plane being perpendicularly oriented with said bottom surface of said plate such that each of said tabs extends downwardly from said plate, said front face of each of said tabs abutting said rear edge of said bed thereby inhibiting said plate from sliding forwardly in said bed when said truck is driving.

4. The assembly according to claim 3, wherein said rear face abuts said front surface of said tailgate when said tailgate is closed thereby inhibiting said plate from sliding rearwardly in said bed when said truck is driving.

5. The assembly according to claim 2, further comprising an annular panel having a lower edge, said lower edge being coupled to said upper surface of said plate such that said annular plate defines said receiver, said annular panel surrounding the bucket when the bucket is placed on said plate for restraining the bucket.

6. A bucket holding assembly for securing a bucket in a bed of a truck, said assembly comprising:
a truck having a bed and a tailgate hingedly attached to said bed, said bed having a top surface and a rear edge, said tailgate having a bottom edge and a front surface, said bottom edge being spaced from said rear edge when said tailgate is positioned in an open position, said front surface lying on a plane being perpendicularly oriented with said top surface of said bed when said tailgate is closed; and
a holding unit being positionable on said bed, said holding unit having a pair of grips which each grip said bed thereby inhibiting said holding unit from sliding in said bed, said holding unit having a receiver for insertably receiving a bucket for securing the bucket on said bed, said holding unit comprising:
a plate having an upper surface, a bottom surface and a perimeter edge extending between said upper surface and said bottom surface, said perimeter edge having a first side, said bottom surface resting against said top surface of said bed having said first side being aligned with said rear edge of said bed;
a pair of tabs, each of said tabs having an upper edge, a rear face and a front face, said upper edge of each of said tabs being coupled to said first side of said perimeter edge of said plate such that each of said tabs defines a respective one of said grips of said holding unit, each of said tabs being oriented to lie on a plane being perpendicularly oriented with said bottom surface of said plate such that each of said tabs extends downwardly from said plate, said front face of each of said tabs abutting said rear edge of said bed thereby inhibiting said plate from sliding forwardly in said bed when said truck is driving, said rear face abutting said front surface of said tailgate when said tailgate is closed thereby inhibiting said plate from sliding rearwardly in said bed when said truck is driving; and
an annular panel having a lower edge, said lower edge being coupled to said upper surface of said plate such that said annular plate defines said receiver, said annular panel surrounding the bucket when the bucket is placed on said plate for restraining the bucket.

7. A method of securing a bucket in a bed of a truck, the steps of the method comprising:
providing a truck having a bed, said bed having a top surface and a rear edge, said truck having a tailgate having a bottom edge;
providing a holding unit having a pair of grips and a receiver;
providing a bucket;
opening said tailgate;
positioning said holding unit on said top surface of said bed such that each of said grips abuts said rear edge of said bed thereby inhibiting said holding unit from sliding forwardly in said bed when said truck is driving;
placing said bucket in said receiver thereby restraining said bucket in said bed; and
closing said tailgate thereby inhibiting said holding unit from sliding rearwardly in said bed when said truck is driving.
